(19) United States
(12) Patent Application Publication
(10) Pub. No.: US 2009/0033182 A1
(43) Pub. Date: Feb. 5, 2009

(54) Manual generator

(75) Inventor: Ji-Xuan Lee, ChanghuaCounty (TW)

Correspondence Address: Ji-Xuan Lee, P.O. Box 44-2049, Taipei, 10668, TW

(73) Assignee: Hongyu Technology Ltd., Co.

(21) Appl. No.: 11/882,359

(22) Filed: Aug. 1, 2007

(51) Int. Cl. H02K 7/116

(52) U.S. Cl. 310/75 B

(57) ABSTRACT

A generator includes a base on which a power generating device and a power storage unit is connected. The power generating device includes a shaft with which a gear set is connected. The power storage unit includes an output member which is located at an outside of the casing of the generator. An operation unit includes a crank and a pedal, the crank is connected with the gear set so as to operate the power generating device. By the gear set, the crank needs to be operated few times to make the shaft of the power generating device to rotate by multiple times of the revolutions so as to efficiently generate power.

### BACKGROUND OF THE INVENTION

(1) Field of the Invention

The present invention relates to a generator with a pedal for the user to operate so as to generate electric power.

(2) Description of the Prior Art

A generator is needed for traveling or camping to a remote place where no electric power is supplied. A portable generator is developed which is operated by gas so that the users can carry the portable generator to the camping area where no power supply is provided. However, the gas-powered generator generates a lot of noise and exhaust air which are not welcomed. Therefore, a manual generator is developed in the market and includes a crank which is rotated by the user to spin the coils to cut the magnetic lines to generate electric power. Nevertheless, the number of revolutions of the output shaft and the crank is the same and this means low efficiency and needs to be improved.

The present invention intends to provide a manual generator which includes a pedal cooperated with a gear set which increases the number of revolutions of the shaft of the generator so that the user operates the pedal few times to obtain sufficient electric power.

### SUMMARY OF THE INVENTION

The present invention relates to a generator that comprises a base on which a power generating device and a power storage unit are connected. The power generating device includes a shaft so as to be cooperated with a gear set, and the power storage unit includes an output member. An operation unit includes a crank and a pedal, wherein the crank is connected with the gear set so as to operate the power generating device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the generator of the present invention;

FIG. 2 is a perspective view to show the generator of the present invention without the casing;

FIG. 3 is an exploded view to show the generator of the present invention;

FIG. 4 is a top view to show the generator of the present invention;

FIGS. 5 and 6 show the two positions that the pedals are operated, and

FIG. 7 shows another embodiment of the generator of the present invention.

### DETAILED DESCRIPTION OF THE PREFERRED EMBODIMENT

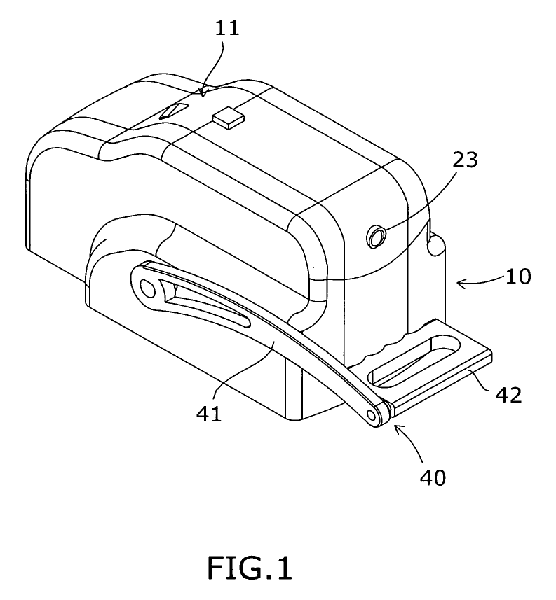

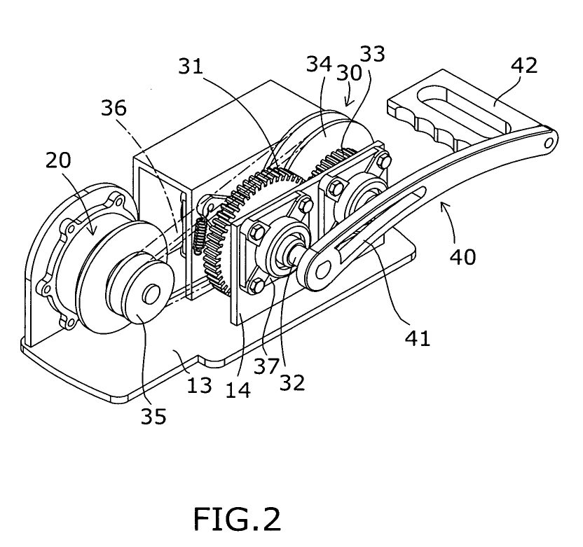

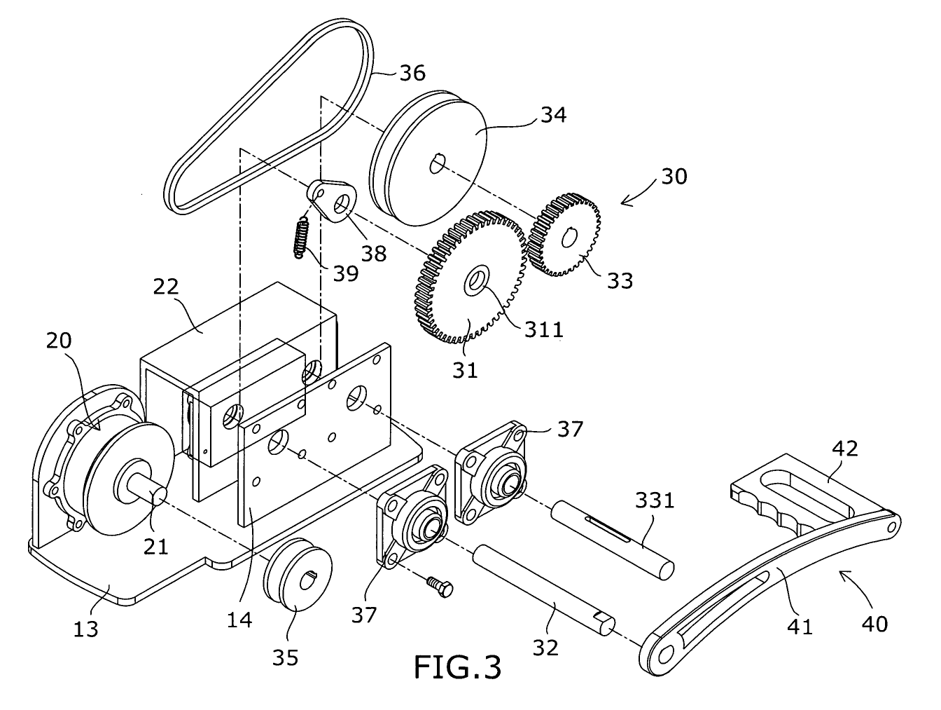

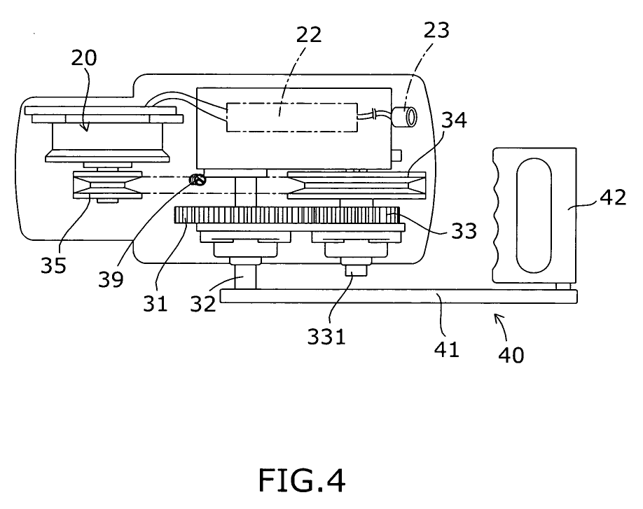

Referring to FIGS. 1 to 4, the generator of the present invention comprises a base 13 on which two boards 14 are connected thereon respectively and the power generating device 20 and the gear set 30 are connected on the two boards 14 respectively. The power generating device 20 includes a shaft 21 and the power storage unit 22 includes an output member 23. A gear set 30 is cooperated with the shaft 21 and an operation unit 40 is connected with the gear set 30 so as to operate the power generating device 20. A casing 11 is mounted on the base 13 to accommodate the power generating device 20, the power storage unit 22 and the gear set 30 therein. The output member 23 can be a cigarette lighter and is located at outside of the casing 11 so as to be connected with an adaptor (not shown) and an appliance. The power that is generated from the power generating device 20 can also be stored in the power storage unit 22.

The gear set 30 includes a first gear 31 and a second gear 33 which is engaged with the first gear 31 and include less number of teeth than the first gear 31. A one-direction bearing 311 is engaged with a central hole of the first gear 31. A first axle 32 extends through one of two support frames 37 on the base 13 and is engaged with the one-direction bearing 311 and is connected to an end of a crank 41 of the operation unit 40. A second axle 331 securely extends through a central hole of the second gear 33 and is connected with a first pulley 34. The second axle 331 further extends through the other support frame 37. A second pulley 35 is securely mounted to the shaft 21 of the power generating device 20 and a belt 36 connected between the first and second pulleys 34, 35. An arm 38 has a first end securely mounted to the first axle 32 and a spring 39 has a first end fixed to a second end of the arm 38, a second of the spring 39 is fixed to the base 13.

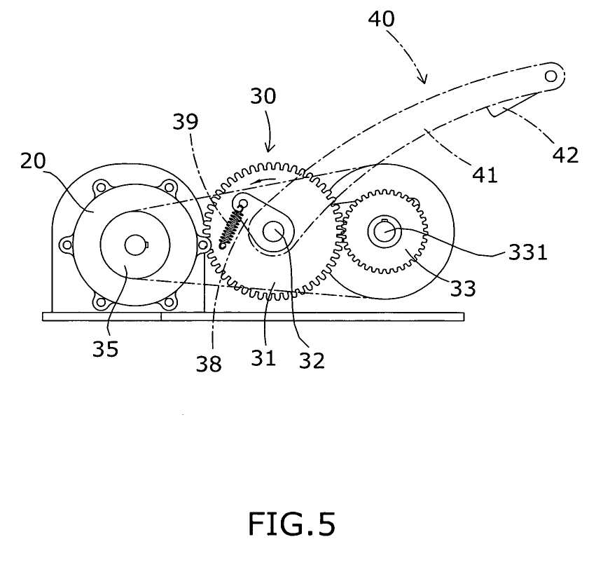

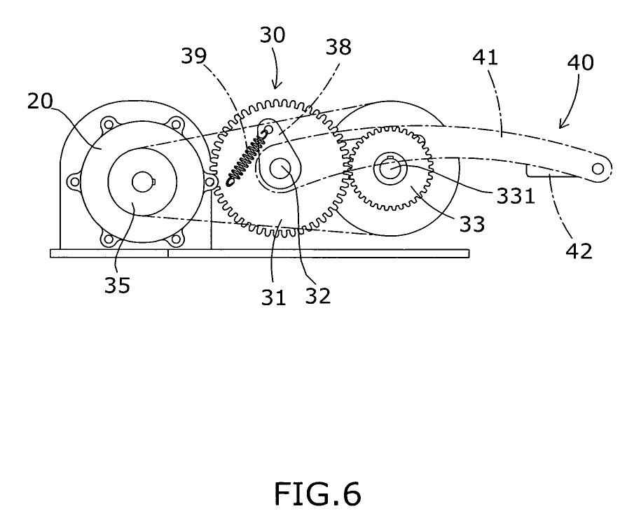

Referring to FIGS. 5 and 6, the user can operates the operation unit 40 by pushing the pedal 42 on the other end of the crank 41 repeatedly to drive the first gear 31 which has more teeth than the second gear 33 which is then rotated several times of revolution of the revolution of the first gear 31. The revolution of the second gear 33 is then transferred to the shaft 21 via the first and the second pulleys 34, 35 and the belt 36 so as to generate electric power. The spring 39 pivots the crank 41 upward whenever the crank 41 is pivoted downward. The one-direction bearing 311 allows the crank 41 to efficiently activate the gear set 30 only when it is pivoted downward. The user than uses the electric power via the output member 23 or store the electric power to the power storage unit 22. Because of the gear set 30 and the user can easily operate the power generating device 20.

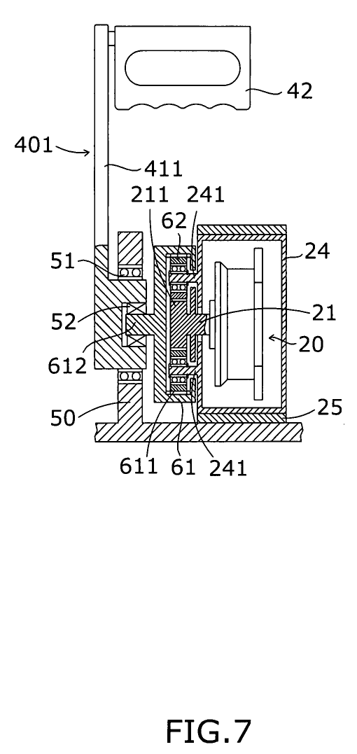

FIG. 7 shows another embodiment of the generator of the present invention wherein the power generating device 20 includes an outer case 24 rested on a positioning member 25 on the base 13 and a plurality of axles 241 extend from the outer case 24. Each axle 241 has a gear 62 mounted thereto. A driving gear 211 is mounted to the shaft 21 of the power generating device 20 and engaged with the gears 62 which are engaged with inner teeth 611 defined in an inner periphery of a wheel 61. The wheel 61 includes a protrusion 612 extending from a center of an outside thereof and the crank 411 is connected with the protrusion 612. A support part 50 is connected on the base 13 and includes a bearing 51 received in a central hole therein. The crank 411 of the operation unit 401 has an end engaged with the bearing 51. The end of the crank 411 includes a recess and a one-direction bearing 52 is received in the recess. The protrusion 612 of the wheel 61 is engaged with the one-direction bearing 52.

While we have shown and described the embodiment in accordance with the present invention, it should be clear to those skilled in the art that further embodiments may be made without departing from the scope of the present invention.

What is claimed is:

1. A generator comprising:
a base on which a power generating device and a power storage unit are connected, the power generating device including a shaft and the power storage unit including an output member;
a gear set cooperated with the shaft, and
an operation unit including a crank and a pedal, the crank connected with the gear set so as to operate the power generating device.

2. The generator as claimed in claim 1, wherein output member is a cigarette lighter.

3. The generator as claimed in claim 1, wherein the gear set includes a first gear and a second gear which is engaged with the first gear, a one-direction bearing is engaged with a central hole of the first gear, a first axle is engaged with the one-direction bearing and is connected to the crank, a second axle securely extends through a central hole of the second gear and is connected with a first pulley, a second pulley is securely mounted to the shaft of the power generating device, a belt connected between the first and second pulleys.

4. The generator as claimed in claim 3 further comprising an arm having a first end securely mounted to the first axle and a spring has a first end fixed to a second end of the arm, a second of the spring is fixed to the base.

5. The generator as claimed in claim 1, wherein two boards are connected on the base and a casing is mounted on the base to accommodate the power generating device, the power storage unit and the gear set therein, the output member is located at outside of the casing, the power generating device and the gear set are connected on the two boards respectively.

6. The generator as claimed in claim 5, wherein two support frames are connected to one of the boards and the first and second axles extend through the two support frames respectively.

7. The generator as claimed in claim 1, wherein the power generating device includes an outer case and a plurality of axles extend from the outer case, each axle has a gear mounted thereto, a driving gear mounted to the shaft of the power generating device and engaged with the gears which are engaged with inner teeth defined in an inner periphery of a wheel, the wheel includes a protrusion extending from a center of an outside thereof, the crank is connected with the protrusion.

8. The generator as claimed in claim 7, wherein a support part is connected on the base and includes a bearing received in a central hole therein, the crank of the operation unit has an end engaged with the bearing, the end of the crank includes a recess and a one-direction bearing is received in the recess, the protrusion of the wheel is engaged with the one-direction bearing.

9. The generator as claimed in claim 7, wherein the outer case is rested on a positioning member on the base.
